(19) United States
(12) Patent Application Publication
(10) Pub. No.: US 2025/0065434 A1
(43) Pub. Date: Feb. 27, 2025

(54) WELDING QUALITY CONTROL APPARATUS

(71) Applicant: FANUC CORPORATION, Yamanashi (JP)

(72) Inventor: Takahiro AOYAGI, Yamanashi (JP)

(21) Appl. No.: 18/726,798

(22) PCT Filed: Jan. 19, 2022
(86) PCT No.: PCT/JP2022/001830

§ 371 Date: Jul. 4, 2024

(51) Int. Cl. B23K 11/25; B25J 11/00

(52) U.S. Cl. CPC B23K 11/252; B25J 11/005

(57) ABSTRACT

A welding quality control apparatus includes: a storage unit to store welding data files relating to a position of a movable electrode and a value of a current flowing between electrodes during a welding period, which are commonly acquired by welding robots and received from welding robot bodies or controllers thereof, together with a part number for individually identifying a part to be welded, a welding number for individually identifying a welding point of the part to be welded, a program ID for identifying a program used in welding the part to be welded, and date and time information; and a search unit to search the stored welding data files in accordance with a search condition relating to at least one of the part number, the welding number, the program ID, and the date and time information, and extract specific welding data files that match the search condition.

### RELATED APPLICATIONS

The present application is a National Phase of International Application No. PCT/JP2022/001830 filed Jan. 19, 2022.

### TECHNICAL FIELD

This disclosure relates to a welding quality control apparatus.

### BACKGROUND ART

In recent years, the use of robot devices equipped with spot welding guns for welding car bodies and the like has become widespread. In welding operations using a spot welding gun, two workpieces to be welded are sandwiched between a movable electrode tip and a fixed electrode tip, and a voltage is applied to the movable electrode tip and the fixed electrode tip while a predetermined welding pressure is being applied thereto, thereby welding the two workpieces. With the automation of welding operations, it has become important to detect welding defects. For example, there is known a technique of determining an abnormality of a welded portion based on data acquired by an external sensor (for example, Patent Literature 1).

The method of detecting an abnormality by an external sensor or the like may not provide correct data because the accuracy and sensitivity of the sensor fluctuate depending on the use environment, which may cause an abnormality to be overlooked. In addition, since the welding robot needs to be equipped with an external sensor to detect abnormalities, the method may not be applicable to existing welding robots, and if the external sensor is expensive, it will lead to an increase in cost. Getting used to relying only on an external sensor for anomaly detection leads to a decline in the technical ability to determine whether or not there is truly an abnormality by looking at data.

### CITATION LIST

### Patent Literature

Patent Literature 1: Japanese Unexamined Patent Application Publication No. 2021-10925

### BRIEF DESCRIPTION OF THE DRAWINGS

FIG. 1 is a diagram showing a welding system including a welding quality control apparatus according to the present embodiment.

FIG. 2 is a functional block diagram of a welding robot shown in FIG. 1.

FIG. 3 is a functional block diagram of the welding quality control apparatus shown in FIG. 1.

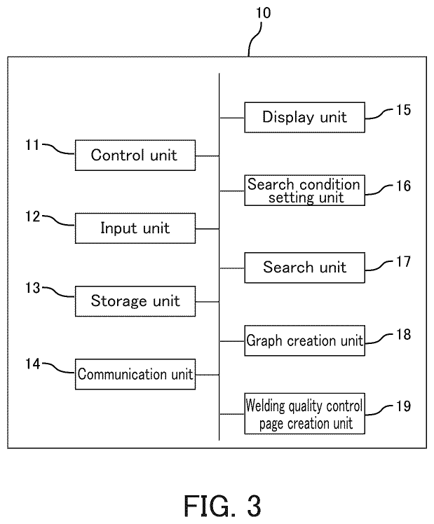

FIG. 4 is a diagram showing an example of a welding quality control page provided by the welding quality control apparatus shown in FIG. 1.

FIG. 5 is a diagram showing an example of a graph showing the change over time of an electrode position, which is displayed on the welding quality control page shown in FIG. 4.

FIG. 6 is a diagram showing an example of a graph relating to the amount of variation in plate thickness of each part, which is displayed on the welding quality control page shown in FIG. 4.

FIG. 7 is a diagram showing an example of a graph showing the change over time of a gun axis current value, which is displayed on the welding quality control page shown in FIG. 4.

FIG. 8 is a diagram showing a graph based on a welding data file extracted using the date and time associated with a welding data file designated by the user as a search condition.

FIG. 9 is a diagram showing a display example of a graph when there is a welding data file to which an abnormality flag is attached.

### DETAILED DESCRIPTION

An welding quality control apparatus according to one aspect of the present disclosure includes: a reception unit configured to receive, from a plurality of welding robots or controllers thereof, a plurality of welding data files relating to a position of a movable electrode and a current value of a current flowing between electrodes during a welding period, which are commonly acquired by the plurality of welding robots, together with a part number for individually identifying a part to be welded, a welding number for individually identifying a welding point of the part to be welded, a program ID for identifying a program used in welding the part to be welded, and date and time information; a storage unit configured to store the plurality of welding data files in association with the part number, the welding number, the program ID, and the date and time information; and a search unit configured to search the plurality of stored welding data files in accordance with a search condition relating to at least one of the part number, the welding number, the program ID, and the date and time information, and extract a plurality of specific welding data files that match the search condition.

Hereinafter, a welding quality control apparatus according to the present embodiment of the present invention will be described with reference to the drawings. In the following description, constituent elements having substantially the same function and configuration are denoted by the same reference numeral, and repetitive descriptions will be given only where necessary.

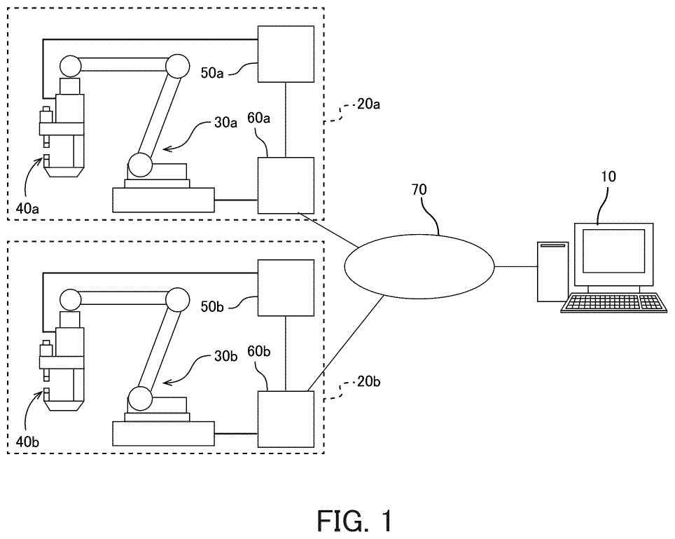

As shown in FIG. 1, a welding quality control apparatus 10 according to the present embodiment is connected to a plurality of welding robots 20 (20a, 20b) via a network 70 such as a LAN. The welding robot 20 (20a, 20b) includes a welding robot body and a control device that controls the welding robot body. The welding robot body is provided by an articulated arm mechanism 30 (30a, 30b) equipped with a spot welding gun 40 (40a, 40b). The control device is constituted by a robot controller 60 (60a, 60b) that controls the articulated arm mechanism 30 and a welding gun controller 50 (50a, 50b) that controls the spot welding gun 40. The robot controller 60 and the welding gun controller 50 are communicatively connected to each other.

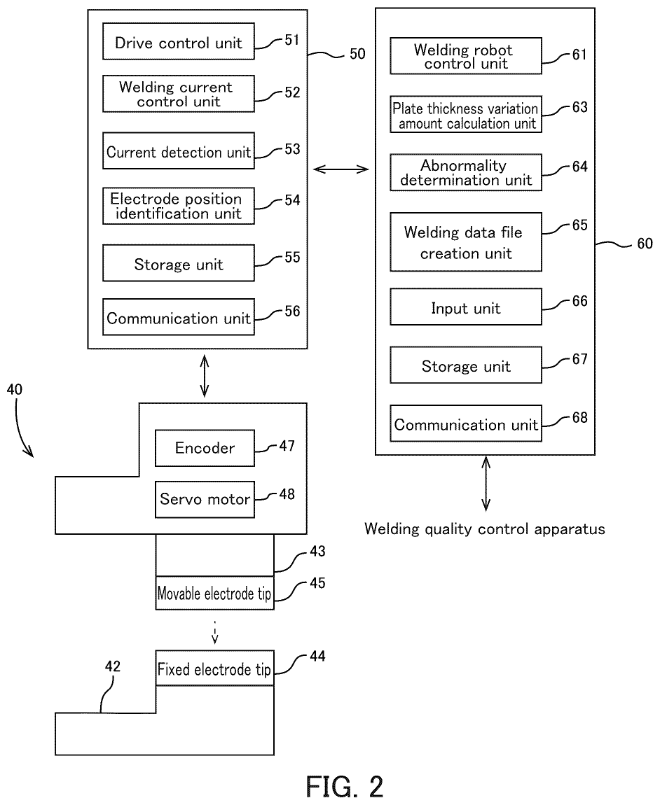

As shown in FIG. 2, the spot welding gun 40 includes a fixed electrode tip 44, a movable electrode tip 45 provided at a position facing the fixed electrode tip 44, a fixed arm 42 that supports the fixed electrode tip 44, a movable arm 43 that supports the movable electrode tip 45 movably along the gun axis, a servo motor 48 that generates power for driving the movement of the movable arm 43, and an encoder 47 that detects the rotational position of the drive shaft of the servo motor 48. The output data of the encoder 47 is sent to the welding gun controller 50.

The welding gun controller 50 includes a drive control unit 51, a welding current control unit 52, a current detection unit 53, an electrode position identification unit 54, a storage unit 55, and a communication unit 56.

The drive control unit 51 controls the drive of the servo motor 48. Specifically, the drive control unit 51 transmits a welding force command specified by a welding program to a motor control unit (not shown) at a timing specified by the welding program. The motor control unit supplies the servo motor 48 with a current for exerting a torque corresponding to the welding force command received from the drive control unit 51. The servo motor 48 is thereby driven with a predetermined torque to achieve the commanded welding force, and the movable electrode tip 45 is moved along the gun axis in a direction toward or away from the fixed electrode tip 44. Note that the drive control unit 51 may be incorporated in the robot controller 60.

The welding current control unit 52 controls the welding current supplied to the fixed electrode tip 44 and the movable electrode tip 45. Specifically, the welding current control unit 52 supplies the electrode tips 44 and 45 with a welding current of a value corresponding to a welding current command specified by the welding program at a timing specified by the welding program.

The current detection unit 53 detects a value of a current that flows when the fixed electrode tip 44 and the movable electrode tip 45 are energized (hereinafter referred to as a gun axis current value). Existing methods can be used to detect the gun axis current value, for example, a current sensor or the like can be used.

Based on the output of the encoder 47, the electrode position identification unit 54 identifies the position of the movable electrode tip 45 (electrode position), which moves along the gun axis during a welding period, at each predetermined sampling cycle. The welding period here is a period from when the movable arm 43 starts to move from a predetermined initial position to when the movable arm 43 returns to the initial position after completion of welding. As being based on the output of the encoder 47, the electrode position corresponds to the amount of rotation of the drive shaft of the servo motor 48, and is not a parameter that guarantees the absolute position of the movable electrode tip 45. The electrode position corresponds to the physical absolute position during the period from when the movable electrode tip 45 starts to move from the initial position in the direction toward the fixed electrode tip 44 to when the movable electrode tip 45 comes into contact with the part to be welded. However, the electrode position does not correspond to the physical absolute position while the movable electrode tip 45 is in contact with and pushed in the part to be welded. Note that the electrode position identification unit 54 may be incorporated in the robot controller 60.

The storage unit 55 stores information on the electrode position identified by the electrode position identification unit 54 and information on the gun axis current value detected by the current detection unit 53.

The communication unit 56 controls transmission and reception of various types of information to and from the robot controller 60. Through the processing of the communication unit 56, the welding gun controller 50 sequentially transmits the information on the electrode position and the information on the gun axis current value to the robot controller 60, and receives control signals of the spot welding gun 40, such as the welding force command and the welding current command, from the robot controller 60.

The robot controller 60 includes a processor configured by a CPU, a GPU, and the like, a RAM that functions as a main memory, a work area, and the like of the processor, and a storage device storing various programs, various types of setting information, and the like. The storage device stores therein a welding program for causing the welding robot 20 to execute a predetermined welding operation. The welding program is prepared for each type of part to be welded. The welding program describes the positions of welding points, the order of welding points, welding force commands and welding current commands at the welding points, and the like. The welding current has information on the position of the movable electrode and the value of the current flowing between the electrodes.

When the welding program is executed by the processor, the robot controller 60 functions as a welding robot control unit 61, a plate thickness variation amount calculation unit 63, an abnormality determination unit 64, a welding data file creation unit 65, an input unit 66, a storage unit 67, and a communication unit 68.

The welding robot control unit 61 controls the welding robot 20. Specifically, the welding robot control unit 61 controls the articulated arm mechanism 30 in accordance with the positions of welding points and the order of the welding points specified by the welding program. Further, the welding robot control unit 61 transmits the welding force command and the welding current command specified by the welding program to the welding gun controller 50 at a timing specified by the welding program. Accordingly, the welding robot 20 executes the welding operation specified by the welding program.

The plate thickness variation amount calculation unit 63 calculates the amount of variation in the plate thickness of the part to be welded before and after welding, based on the change over time of the electrode position received from the welding gun controller 50. For example, the amount of variation in the plate thickness can be calculated based on the difference between the electrode position when the electrode comes into contact with the part to be welded and the electrode position when the welding of the part to be welded is completed.

The input unit 66 inputs a user operation through an input device, such as a keyboard, a mouse, a teaching operation panel, or the like, to the robot controller 60. Specifically, setting information necessary for causing the welding robot 20 to perform a predetermined welding operation is input to the robot controller 60 by a user operation. The setting information includes a part type ID for identifying the type of the part to be welded and a program ID for identifying the welding program used for welding. The storage unit 67 stores various types of information (electrode position, gun axis current value) received from the welding gun controller 50 and a welding data file created by the welding data file creation unit 65 to be described later. The communication unit 68 controls transmission and reception of various types of information between the welding gun controller 50 and the welding quality control apparatus 10. Based on the completion of welding at a welding point, the robot controller 60 transmits a welding data file relating to the welding point to the welding quality control apparatus 10 through the processing of the communication unit 68. Further, the robot controller 60 transmits a command value specified by the welding program to the welding gun controller 50, and receives information on the electrode position and information on the gun axis current value from the welding gun controller 50.

The welding data file creation unit 65 creates a welding data file in which data relating to the gun axis current value during the welding period, data relating to the electrode position during the welding period, and data relating to the amount of variation in the plate thickness of the part to be welded before and after welding are compiled as a data body, and a robot ID for identifying the welding robot 20, a part type ID for identifying the type of the part to be welded part, a part number for individually identifying the part to be welded, a welding number for individually identifying the welding point of the part to be welded, a program ID for identifying the welding program used for welding the part, and date and time information are associated with the data body. The welding data file is created by the welding data file creation unit 65 each time welding at a welding point is completed, stored in the storage unit 67, and transmitted to the welding quality control apparatus 10. The part type ID and the program ID are input by a user operation. The part number is assigned to each part to be welded as a serial number from the start of welding. The welding number is specified by the welding program. The date and time information typically includes information on the welding start date and time and the welding end date and time.

The abnormality determination unit 64 determines whether or not the welding was successful. For example, when a power failure or the like occurs during a welding operation, the abnormality determination unit 64 determines that an abnormality may have occurred during the welding operation and that welding may have failed. An abnormality flag indicating that welding was performed under abnormality determination is attached to the welding data file corresponding to the welding point for which an abnormality during the welding operation has been determined by the abnormality determination unit 64.

The welding quality control apparatus 10 includes hardware similar to that of a general PC, such as a processor, a ROM, a RAM, a storage device, and an input/output interface. The storage device stores therein a welding quality control program. When the welding quality control program is executed by the processor, the welding quality control apparatus 10 functions as a control unit 11, an input unit 12, a storage unit 13, a communication unit 14, a display unit 15, a search condition setting unit 16, a search unit 17, a graph creation unit 18, and a welding quality control page creation unit 19.

The control unit 11 comprehensively controls the parts constituting the welding quality control apparatus 10.

The input unit 12 inputs a user operation through an input device, such as a keyboard, a mouse, a teaching operation panel, or the like, to the welding quality control apparatus 10. Specifically, a search condition is input to the welding quality control apparatus 10 in accordance with a user operation. The search condition includes at least one value of the part type ID, the part number, the welding number, the program ID, and the date and time information.

The communication unit 14 transmits and receives various types of information to and from the robot controller 60. Through the processing of the communication unit 14, the welding quality control apparatus 10 receives a welding data file from the robot controller 60. As described above, the data body of the welding data file includes data on the electrode position during the welding period, the amount of variation in the plate thickness of the part to be welded before and after the welding, and the gun axis current value during the welding period, and is accompanied by the robot ID, the part type ID, the part number, the welding number, the program ID, and the date and time information. The welding data file received from the robot controller 60 is stored in the storage unit 13.

The search condition setting unit 16 sets search conditions using various methods. Specifically, the search condition setting unit 16 sets a search condition in accordance with a user operation via the input unit 12. In addition, the search condition setting unit 16 sets at least one of the robot ID, the part type ID, the part number, the welding number, the program ID, and the date and time information associated with a welding data file to which the abnormal flag is attached as the search condition. The search condition setting unit 16 sets at least one of the part type ID, the part number, the welding number, the program ID, and the date and time information associated with a welding data file arbitrarily designated by the user as the search condition.

The search unit 17 searches a plurality of welding data files stored in the storage unit 13 in accordance with the search condition set by the search condition setting unit 16, and extracts a plurality of specific welding data files that match the search condition.

The graph creation unit 18 creates, based on the plurality of specific welding data files extracted by the search unit 17, a plurality of graphs showing the change over time of the electrode position during the welding period, a graph showing the amount of variation in the plate thickness before and after welding for each part, and a plurality of graphs showing the change over time of the gun axis current value during the welding period. When a welding data file to which an abnormality flag is attached is included in the plurality of specific welding data files, the graph creation unit 18 creates a graph (plot) based on the welding data file to which an abnormality flag is attached so as to be distinguishable from the graphs (plots) based on welding data files to which no abnormality flag is attached.

The welding quality control page creation unit 19 generates data of a welding quality control page to be described later. The welding quality control page created by the welding quality control page creation unit 19 is displayed on the display unit 15.

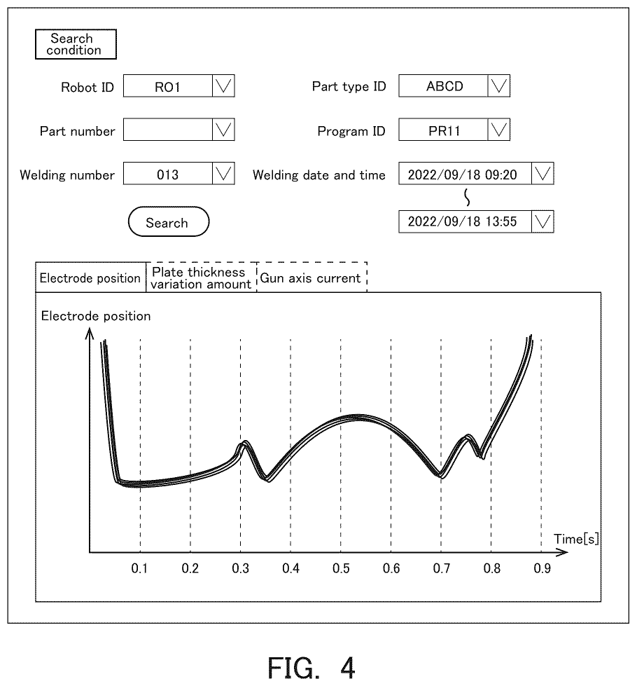

The welding quality control page created by the welding quality control page creation unit 19 will be described below with reference to FIG. 4 to FIG. 9. The welding quality control page is a page for the user to confirm the welding quality of each welding point.

As shown in FIG. 4 to FIG. 7, a plurality of search conditions are displayed on the welding quality control page to allow the user to input a search condition. The search conditions include “robot ID”, “part type ID”, “part number”, “program ID”, “welding number”, and “welding date and time”. For example, if the user wishes to confirm the welding quality of the specific welding point of each part, the user may input the search conditions “part type ID” and “welding number”. Further, if the user wishes to limit the search by the time of welding, the user may input the search condition “welding date and time”. Further, if the user wishes to limit the search by the welding robot 20, the user may input the search condition “robot ID”. Further, if the user wishes to limit the search by the welding program used, the user may input the search condition “program ID”. In this manner, the user can set the search condition by inputting a search condition in accordance with the welding points the user wishes to confirm.

When a search condition is input by a user operation, data items based on a plurality of specific welding data files that match the search condition are listed in a tabular form on the welding quality control page. The user can confirm the data table to determine whether or not a welding defect may have occurred at any welding point. When an instruction to display graphs, such as clicking of a graph output button, is input, a graph showing the change over time of the electrode position, a graph showing the amount of variation in the plate thickness of each part, and a graph showing the change over time of the gun axis current value, which have been created based on the plurality of specific welding data files that match the search condition, are displayed as shown in FIG. 4 to FIG. 7. In the graph shown in FIG. 4, which shows the change over time of the electrode position, the vertical axis indicates the electrode position, and the horizontal axis indicates the passage of time. In the welding quality control pages shown in FIG. 4 to FIG. 7, these graphs can be switched by changing the display data of the vertical axis or by tabs.

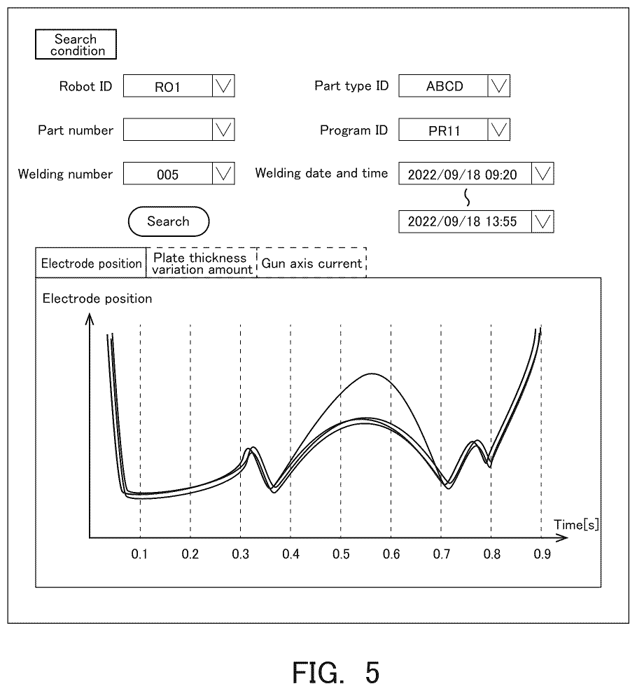

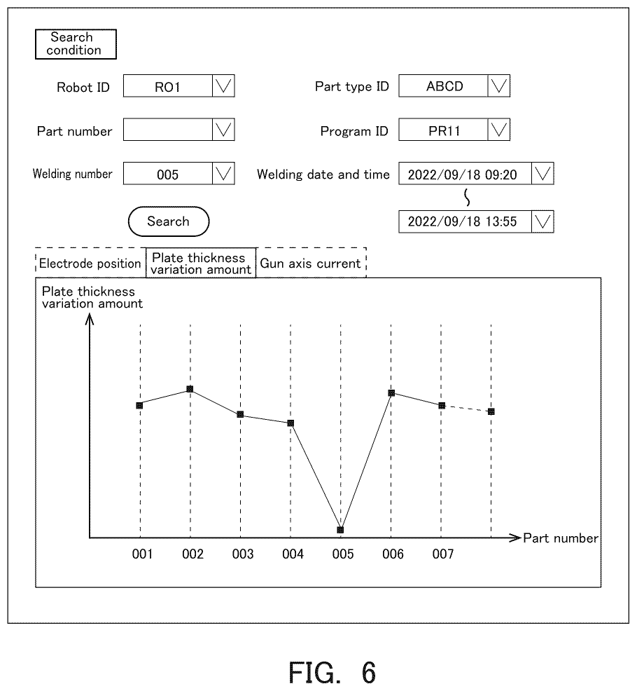

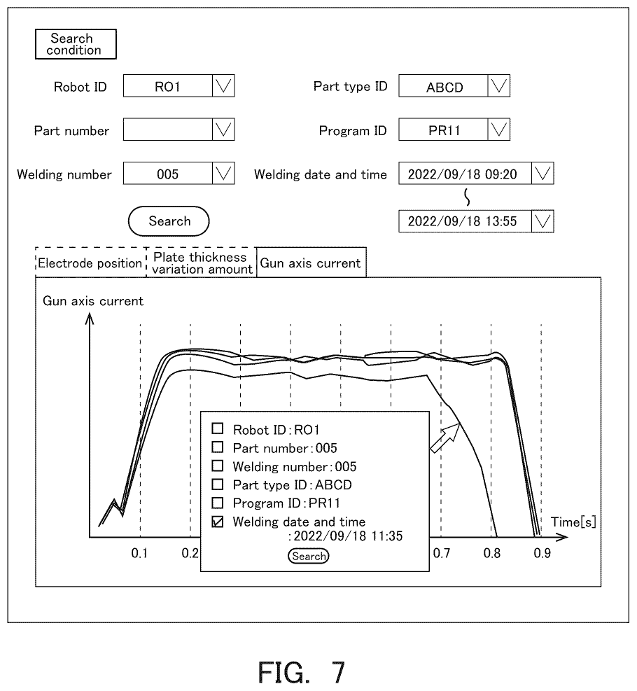

As shown in FIG. 4 and FIG. 5, a plurality of graphs showing the change over time of the electrode position, which have been created by the graph creation unit 18, are collectively displayed in a time-aligned and overlapping manner. As shown in FIG. 6, a plurality of plots showing the amount of variation in the plate thickness are collectively displayed with the part number on the horizontal axis and the amount of variation in the plate thickness on the vertical axis so that specific welding data files can be compared at once. As shown in FIG. 7, a plurality of graphs showing the change over time of the gun axis current value, which have been created by the graph creation unit 18, are collectively display in a time-aligned and overlapping manner.

The welding quality control apparatus 10 according to this embodiment achieves the following effects.

That is, by inputting a search condition displayed on the welding quality control page provided by the welding quality control apparatus 10, the user can extract welding data files that match at least one of the type of the welding robot, the type of the part to be welded, the individual part, the welding point, the date and time, and a combination thereof, and can view a graph showing the change over time of the electrode position, a graph showing the amount of variation in the plate thickness, and a graph showing the change over time of the gun axis current value based on a plurality of welding data files that share at least a part of the search conditions. By viewing these graphs, the user can determine whether or not a welding defect may have occurred at any welding point. In other words, the welding quality control apparatus 10 according to the present embodiment can assist the user in determining a welding defect.

A plurality of graphs showing the change over time of the electrode position and a plurality of graphs showing the change over time of the gun axis current value are collectively displayed in a time-aligned and overlapping manner, and the amounts of variation in the plate thickness for the respective parts are collectively displayed. As a result, the user viewing them can more easily determine whether or not there is a welding defect. For example, as shown in FIG. 4, when all of the plurality of graphs showing the change over time of the electrode position show the same tendency, the user can determine that there is no welding defect. On the other hand, as shown in FIG. 5, when there is a graph showing a clearly different tendency from the other graphs among the plurality of graphs showing the change over time of the electrode position, the user can determine that a welding defect may have occurred.

Of course, whether or not there is a welding defect can also be determined by viewing other types of graphs. As shown in FIG. 6, the amount of variation in the plate thickness of the part number “005” is obviously smaller than those of the other part numbers. Therefore, it can be determined that welding may have not been properly performed and an abnormality may have occurred in the part number “005”. In addition, it may be possible to determine that the welding operation may have been performed under the condition with the abnormality for the part numbers subsequent to the part number “005”. As shown in FIG. 7, the user can determine that a welding defect may have occurred when one of the plurality of graphs showing the change over time of the gun axis current value shows a clearly different tendency from the other graphs.

Since the possibility of a welding defect can be determined from three types of graphs: a graph showing the change over time of the electrode position, a graph showing the amount of variation in the plate thickness of each part, and a graph showing the change over time of the gun axis current value, the possibility of a welding defect can be determined more accurately, and the cause of the welding defect can be analyzed from various perspectives. In addition, the user can obtain, as knowledge, the tendency of the graph when there is a welding defect and the tendency of the graph when there is no welding defect.

In the present embodiment, the electrode position, the amount of variation in the plate thickness, and the gun axis current value are used as parameters for determining the possibility of a welding defect. The electrode position and the amount of variation in the plate thickness are calculated based on the output of the encoder 47 which is already provided in the spot welding gun 40. The gun axis current value is calculated based on the output of the current detection unit 53 which is already provided in the welding gun controller 50 which controls the spot welding gun 40. As described above, since the technique uses parameters that can be commonly acquired by the existing spot welding guns 40, there is no need to equip the welding robot 20 with a dedicated external sensor just to determine the possibility of a welding defect, and the technique can be applied to existing spot welding guns 40, and can be said to be very versatile.

When an abnormality occurs in the welding robot 20 itself, simply collecting welding data files from a single welding robot 20 would not show any difference between graphs, and the abnormality may be overlooked without being detected. The welding quality control apparatus 10 according to the present embodiment can collect a plurality of welding data files from a plurality of welding robots 20. Accordingly, if there are a plurality of welding robots 20 that perform welding operations on the same type of part using the same welding program, an abnormality in welding by the welding robots 20 can be reliably found by comparing data among the plurality of welding robots 20.

Since the welding quality control apparatus 10 according to the present embodiment centrally manages a plurality of welding data files generated by a plurality of welding robots 20, there is no need for the user to visit the site and operate the welding robots 20 in order to confirm the welding data files, and the user can access the welding quality control apparatus 10 through the network 70 even from remote locations and confirm the welding data files.

In the welding quality control apparatus 10 according to the present embodiment, at least one of the robot ID, the part type ID, the part number, the welding number, the program ID, and the date/time information attached to a welding data file that is the data source of the graph arbitrarily designated by the user among the plurality of graphs displayed on the welding quality control page can be set as the search condition. For example, when a graph (welding point) with a possible welding defect is found in the welding quality control page, the welding defect is likely to be caused by at least one of the welding robot type, the part type, the part, the welding point, the welding program, and the date and time specified by the welding information attached to the welding data file that is the data source of the graph, and a welding defect may have occurred at welding points for which a welding operation was performed under a condition at least partially common to the welding point with a possible welding defect. For example, if the welding defect is caused by a power failure, a welding defect may also have occurred due to the power failure at the welding points for which a welding operation was performed during the same time period. In addition, if a welding defect is found in a specific welding robot 20, a welding defect may also have occurred at the other welding points welded by that specific welding robot 20.

As shown in FIG. 7, when a graph presumed to exhibit a welding defect is designated from among a plurality of graphs displayed on the welding quality control page, welding information of the welding point corresponding to the graph is displayed. Further, at least one of these welding information can be set as the search condition. As a result, it is possible to save the trouble of setting the search condition by the user and to extract welding data files that are likely to exhibit a welding defect. Controlling welding quality with a plurality of welding robots in operation has placed a heavy burden on managers. Since welding data files with a possible welding defect can be extracted and confirmed based on one welding defect, it is possible to more easily control the welding quality and to reduce the possibility of overlooking welding defects.

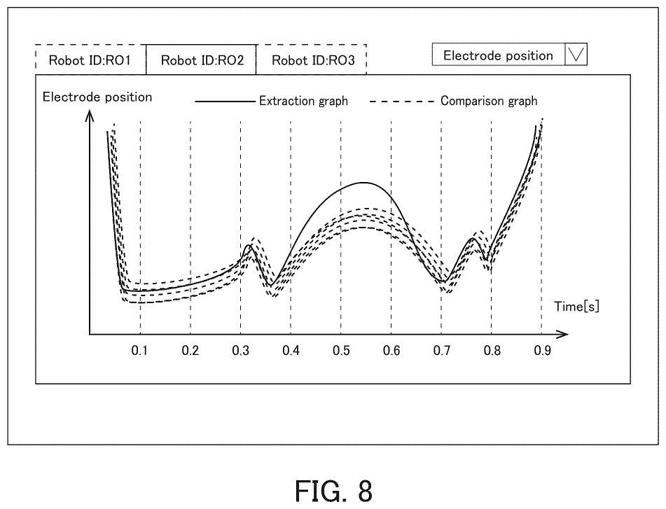

As shown in FIG. 7, by designating the date and time information among the search conditions, it is possible to extract a welding data file of the same date and time “2022 Sep. 18 11:35” as the specific graph presumed to exhibit a welding defect or near that data and time. Then, as shown in FIG. 8, a graph (extraction graph) based on the extracted welding data file and a plurality of graphs (comparison graphs) based on a plurality of specific welding data files whose part type ID, welding number, and program ID match those of the extracted welding data file can be collectively displayed in an overlapping manner.

As shown in FIG. 8, by viewing the graphs based on the welding data files collected from respective welding robots 20 at a specific date and time, the user can confirm whether a graph corresponding to a welding point welded at the same time as the date and time when the welding defect occurred shows a similar tendency or a clearly different tendency with respect to the other plurality of graphs, and can determine where or not there is a welding defect. Here, as shown in FIG. 7, the graphs corresponding to welding points welded at the same time by a welding robot 20 with the robot ID “RO1” and a welding robot 20 with the robot ID “RO2” show different tendencies from the other graphs; therefore, it can be inferred that an abnormality such as a power failure occurred throughout the factory on that date and time.

As described above, when a graph (welding point) with a possible welding defect is confirmed in the welding quality control page, it is possible to efficiently confirm where the cause of the welding defect is by confirming a plurality of graphs (welding points) sharing some welding conditions with that graph (welding point). In addition, when the possibility of a welding defect is determined, the occurrence of similar welding defects can be easily confirmed for each part type, each part, each welding point, each program, and each date and time, so that overlooking of welding defects can be prevented.

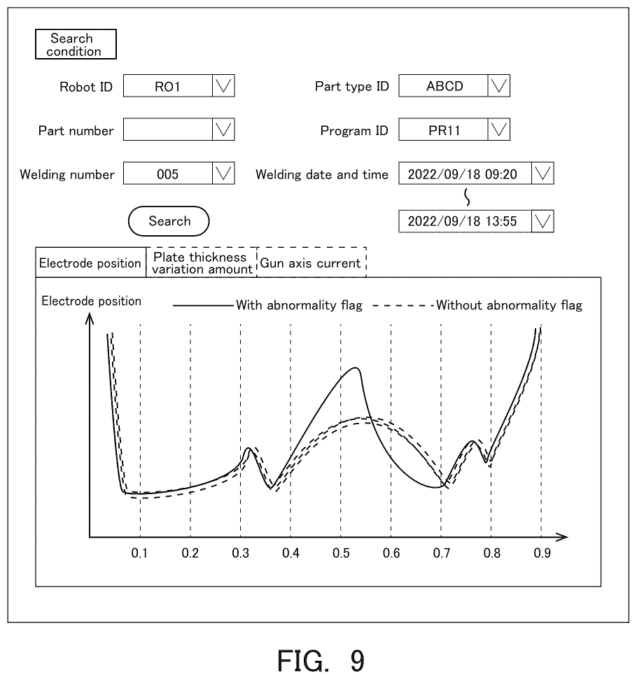

When a specific welding data file to which an abnormality flag is attached is included in the plurality of specific welding data files extracted by the search unit 17, it is desirable that the graph based on the specific welding data file to which an abnormality flag is attached can be distinguished from the graphs based on the specific welding data files to which an abnormality flag is not attached. Therefore, for example, as shown in FIG. 9, a graph based on the welding data file to which an abnormality flag is attached is represented by a solid line, and graphs based on the welding data files to which an abnormality flag is not attached are represented by broken lines. Of course, the graphs may be identified by the color of the line of the graph, instead of the type of the line of the graph. Thus, the user can easily identify the graphs to which an abnormality flag is attached.

As long as the welding quality control apparatus 10 according to the present embodiment can collect welding data from the welding robot 20, the embodiment is not limited to the present embodiment. For example, the welding quality control apparatus 10 may be directly connected to the welding robot 20 by a cable. In addition, the welding quality control apparatus 10 may be connected wirelessly or by wire to an overall control apparatus, such as a PLC, which performs overall control of a plurality of welding robots 20.

In the present embodiment, the functions of the electrode position identification unit 54 and the plate thickness variation amount calculation unit 63 are provided on the welding robot 20 side. However, as long as the electrode position and the amount of variation in the thickness variation can be calculated based on the output of the encoder 47, all or some of these functions may be included in the welding quality control apparatus 10. Further, the welding robot 20 may have some or all of the functions of the welding quality control apparatus 10. Further, an external device may have some of the functions of the robot controller 60 and the welding quality control apparatus 10, for example, the function of the storage unit 13 of the welding quality control apparatus 10.

In the present embodiment, the welding data file includes three parameters of the electrode position, the amount of variation in the plate thickness, and the gun axis current value, and three types of graphs based on the respective parameters can be displayed. However, if it is possible for the user to determine a welding point with a possible welding defect, it is sufficient for the welding data file to include at least one of the three parameters.

In the present embodiment, the welding data file is accompanied by the robot ID, the part type ID, the part number, the welding number, the program ID, and the date and time information, but the part type ID do not have to be included as the accompanying information since the part type may be uniquely identified once the welding program is determined. In addition, even if the parts are of the same type, their performance may differ depending on the factory where they are produced. Accordingly, the welding data file may include a rod ID for identifying the production rod of the part type. In addition, the spot welding gun 40 attached to the articulated arm mechanism 30 may be changed for reasons such as maintenance. Thus, the welding data file may include a gun ID for identifying the spot welding gun 40. In addition, the welding data file may be accompanied by various parameters that may cause changes in the welding operation, such as weather, temperature, humidity, the installation location of the welding robot 20, the elapsed time since the welding robot 20 was maintained, and the like, and these may be set as the search condition.

While some embodiments of the present invention have been described, these embodiments have been presented as examples, and are not intended to limit the scope of the invention. These embodiments can be implemented in various other forms, and various omissions, replacements, and changes can be made without departing from the spirit of the invention. These embodiments and their modifications are included in the scope and spirit of the invention and are included in the scope of the claimed inventions and their equivalents.

1. A welding quality control apparatus connected to a plurality of welding robots, comprising:
a reception unit configured to receive, from the plurality of welding robots or controllers thereof, a plurality of welding data files relating to a position of a movable electrode and a current value of a current flowing between electrodes during a welding period, which are commonly acquired by the plurality of welding robots, together with a part number for individually identifying a part to be welded, a welding number for individually identifying a welding point of the part to be welded, a program ID for identifying a program used in welding the part to be welded, and date and time information;
a storage unit configured to store the plurality of welding data files in association with the part number, the welding number, the program ID, and the date and time information; and
a search unit configured to search the plurality of stored welding data files in accordance with a search condition relating to at least one of the part number, the welding number, the program ID, and the date and time information, and extract a plurality of specific welding data files that match the search condition.

2. The welding quality control apparatus according to claim 1, further comprising:
a graph creation unit configured to create, based on the plurality of extracted specific welding data files, a plurality of graphs showing change over time in the position of the movable electrode and a plurality of graphs showing change over time in the current value; and
a display unit configured to collectively display the plurality of graphs showing the change over time in the position of the movable electrode and the plurality of graphs showing the change over time in the current value in a time-aligned and overlapping manner.

3. The welding quality control apparatus according to claim 1, further comprising:
a search condition setting unit configured to set, as the search condition, a value related to at least one of the welding number, the part number, the program ID, and the date and time information in accordance with a user operation.

4. The welding quality control apparatus according to claim 1, further comprising:
a search condition setting unit configured to set, as the search condition, a value related to at least one of the welding number, the part number, the program ID, and the date and time information associated with one welding data file arbitrarily designated by a user, wherein
the plurality of specific welding data files extracted by the search unit share at least one of the welding number, the part number, the program ID, and the date and time information with the one designated welding data file.

5. The welding quality control apparatus according to claim 1, further comprising:
a search condition setting unit configured to set, as the search condition, a value related to at least one of the welding number, the part number, the program ID, and the date and time information associated with one welding data file accompanied by information indicating an abnormality during a welding operation among the plurality of welding data files, wherein
the plurality of specific welding data files extracted by the search unit share at least one of the welding number, the part number, the program ID, and the date and time information with the one welding data file.

6. The welding quality control apparatus according to claim 1, wherein the welding data file includes data on an amount of variation in plate thickness of the part to be welded before and after welding.
